(19) United States
(12) Patent Application Publication
(10) Pub. No.: US 2009/0019160 A1
(43) Pub. Date: Jan. 15, 2009

(54) METHOD AND SYSTEM FOR WORKLOAD MANAGEMENT UTILIZING TCP/IP AND OPERATING SYSTEM DATA

(75) Inventor: Thomas P. Schuler, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/776,651

(22) Filed: Jul. 12, 2007

(51) Int. Cl. G06F 15/173

(52) U.S. Cl. 709/226

(57) ABSTRACT

A method for monitoring and managing workloads and data exchange in computing environments, includes: obtaining a foreign address from a set of netstat information by a collecting system; utilizing the foreign address to find the corresponding netstat information for a foreign system; wherein the process of obtaining foreign addresses is carried out in a recursive manner until the collecting system records one or more systems being utilized by applications running via transmission control protocol/Internet protocol (TCP/IP) communications, and until the collecting system determines how the systems are interconnected; monitoring connections between the collecting system and the one or more systems to determine if and where a bottleneck has occurred; wherein the bottleneck occurs when the send and receive buffers are full, and the applications may no longer send data to the receive buffers; and rectifying the bottleneck by adjusting the amount of system resources the applications may use.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to computer systems and networks, and more particularly to a method and system for a performance management tool that monitors and manages work and data exchange in a computing/information technology (IT) environment.

2. Description of the Related Art

International Business Machines Corporation's Enterprise Workload Manager (EWLM) is a performance management tool that monitors and manages work that runs in a computing/information technology (IT) environment. EWLM provides definitions of specific performance goals, and is configured to monitor application-level transactions separate from operating system processes. Furthermore, EWLM facilitates the assignment of performance goals to specific work. EWLM provides a view of central processing unit (CPU) usage for systems within a domain, as well as a determination of which work contributes the most to the overall system CPU usage. EWLM provides transaction response times and topologies, and assists in answering the following:
Are work requests completing successfully? If not, where are they failing?
Are application-level transactions completing according to performance goals?
Are operating system processes completing according to performance goals?
Is the work for an entire partition completing according to performance goals?
Are successful work requests completing within the expected response time?If not, where are the bottlenecks?
How many work requests are completed during specific time intervals compared to previous time intervals? Is the workload growing?
Do the system-level resources ensure optimal performance? If not, can processing power be shifted to alleviate bottlenecks?
Is the workload balanced to ensure optimal performance? If not, can work be redirected to other systems to alleviate bottlenecks?
Are Service Level Agreements (SLAs) that define specific performance results being met? If not, what can be done to meet the goals?

The EWLM answers these questions by identifying work requests based on business priority, tracking the performance of work requests across server and subsystem boundaries, and managing the underlying physical and network resources to achieve specified performance goals. The EWLM determines the flow of transaction activity across middleware and across platforms. Through gathering information on how the transactions are performing versus desired performance goals, EWLM can make various adjustments on these platforms such as adjusting partition sizes on logical partitioning (LPAR) systems, making CPU adjustments such as job priority or changing the weighting used by load balancing routers. This ability to collect performance information is directly tied to applications using an application response measurement (ARM) interface (a set of application program interfaces (APIs) defined by a standards body) for collecting information. The ARM standard describes a common method for integrating enterprise applications as manageable entities. The ARM standard allows users to extend their enterprise management tools directly to applications creating a comprehensive end-to-end management capability that includes measuring application availability, application performance, application usage, and end-to-end transaction response time. However, if some applications used in processing transactions are not ARM instrumented, an EWLM's ability to monitor transactions or make adjustments in the workload is seriously compromised. In addition, while the use of ARM APIs allows the most complete picture of the flow of transaction activity across middleware and across platforms to be collected, the limited number of ARM instrumented middleware and applications restricts the accuracy and usefulness of that information. Therefore, there is a need for an alternative means, which is not dependent on ARM instrumented middleware and applications, for managing and monitoring transactions and workloads in computer systems and networks.

### SUMMARY OF THE INVENTION

Embodiments of the present invention include a method and system for monitoring and managing workloads and data exchange in computing environments wherein the method includes: obtaining a foreign address from a set of netstat information of a first system by a collecting system; utilizing the foreign address to find the corresponding set of netstat information for a first foreign system; wherein the process of obtaining foreign addresses is carried out in a recursive manner until the collecting system records one or more systems being utilized by one or more applications running on the collecting system via transmission control protocol/Internet protocol (TCP/IP) communications, and until the collecting system determines how the systems are interconnected; monitoring connections between the collecting system and the one or more systems to determine if and where a bottleneck has occurred; wherein the bottleneck occurs when one or more send and receive buffers are full, and the one or more applications may no longer send data to the one or more receive buffers; and rectifying the bottleneck by adjusting the amount of system resources the one or more applications may use.

A system for monitoring and managing workloads and data exchange in a computing environment, the system comprising: a computing environment; a set of hardware and networking resources; an algorithm implemented on the set of hardware and networking resources; wherein the algorithm is configured to obtain a foreign address from a set of netstat information of a first network resource by a collecting network resource; wherein the algorithm utilizes the foreign address to find the corresponding set of netstat information for a first foreign network resource; wherein the algorithm operates in a recursive manner until the foreign addresses of one or more network resources utilized by one or more applications running on a collecting network resource via transmission control protocol/Internet protocol (TCP/IP) communications are recorded by the collecting network resource, and until the collecting network resource determines how the one or more network resources are interconnected; wherein the algorithm monitors connections between the collecting network resource and the one or more network resources to determine if and where a bottleneck has occurred; wherein the bottleneck occurs when one or more send and receive buffers associated with the collecting network resource and the one or more network resources are full, and the one or more applications may no longer send data to the one or more receive buffers; and wherein the algorithm rectifies the bottleneck by adjusting the amount of network resources the one or more applications may use.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a performance management tool that monitors and manages work and data exchange in a computing/information technology (IT) environment.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram of exemplary interaction of computing systems that implement performance management tools according to embodiments of the invention.

FIG. 2 is a flow diagram of an algorithm of a performance management tool according to an embodiment of the invention.

FIG. 3 illustrates a system for implementing embodiments of the invention.

The detailed description explains the preferred embodiments of the invention, together with advantages and features, by way of example with reference to the drawings.

### DETAILED DESCRIPTION

Embodiments of the invention provide a means for a performance management tool that monitors and manages work and data exchange in a computing/information technology (IT) environment. Embodiments of the invention utilize existing transmission control protocol/Internet protocol (TCP/IP) and operating system (OS) instrumentation available on computer network platforms to provide users autonomic workflow adjustment, monitoring, and control. Embodiments of the invention utilize existing capabilities found in TCP/IP and OS implementations to determine relationships between applications and where potential bottlenecks exist. Using TCP, applications on networked hosts can create connections to one another, over which they can exchange streams of data using stream sockets.

A stream socket is a type of internet socket which provides a connection-oriented, sequenced, and unduplicated flow of data without record boundaries, with well-defined mechanisms for creating and destroying connections and for detecting errors. Stream sockets are implemented on top of a TCP layer, so that applications can ran across any networks using TCP/IP protocols. The TCP protocol guarantees reliable and in-order delivery of data from sender to receiver. TCP also distinguishes data for multiple connections by concurrent applications (e.g., Web server and e-mail server) running on the same host.

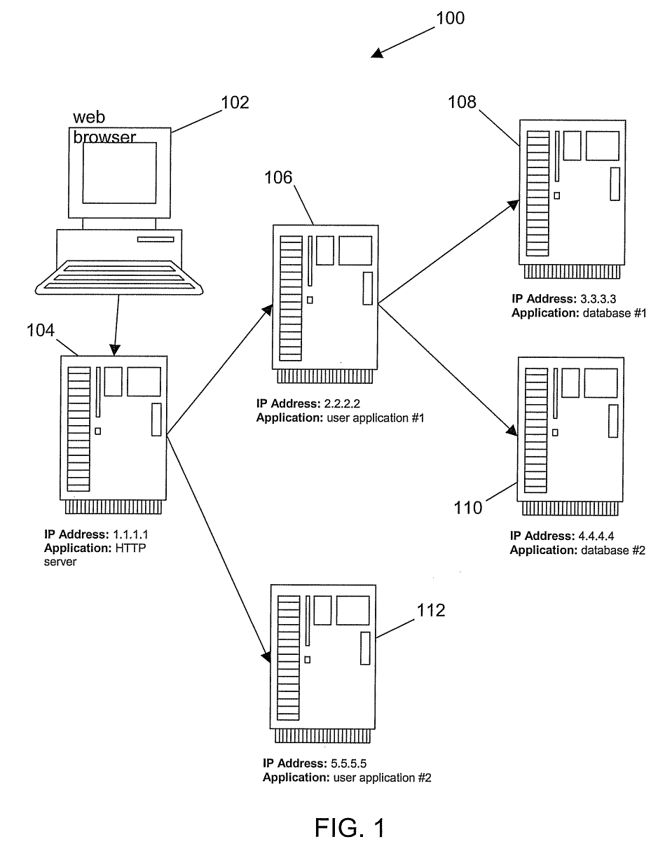

FIG. 1 illustrates an exemplary network 100 for implementing an embodiment of the invention. Within the network 100, it is assumed that the edge application 102 (e.g., an application that users directly interact with, and for which a company wants to manage transactions) and the HTTP server 104, are identified to a systems management workload manager, such as EWLM. It is further assumed that there are agents for the workload manager running on all the systems (104, 106. 108, 110, and 112) that send information to the workload manager collecting this information. Each of the systems (104, 106, 108, 110, and 112) has a unique IP address assigned. With this information, the systems workload manager can build up information about all the other applications and systems that are involved in handling transactions. The following techniques may be used to build up this information view:
On HTTP server 104 (system IP 1.1.1.1), TCP/IP information (such as available via “netstat” (network statistics), a command-line tool that displays incoming and outgoing network connections, routing tables, and a number of network interface statistics) can be used to determine which other systems the edge application 102 directly connects to. Through recursion throughout the network, each system can be identified.
In similar manner, information about each process (or application) can be determined, because each TCP/IP connection is associated with a specific process ID.
Through TCP/IP, certain aspects about the applications can be determined by examining the amount of data in each connection's send and receive buffer. If the connection of the sender is blocked because the receiver is not receiving data quickly enough, that would be a good indication that the receiver is not working as quickly as required and that some sort of adjustment in that applications environment is necessary such as increasing job priority, providing more memory, changes in partition size, etc.

Table 1 is sample of information that the netstat command may provide a workload manager.

TABLE 1
C:\ewlm_local\EWLM-R3-B65.0-7210\eWLM\bin>netstat -aon
Active Connections

| Proto | Local Address | Foreign Address | State | PID |
|---|---|---|---|---|
| TCP | 9.10.110.33:1763 | 9.17.136.76:1533 | ESTABLISHED | 2212 |
| TCP | 9.10.110.33:1796 | 9.56.227.95:1352 | ESTABLISHED | 4952 |
| TCP | 9.10.110.33:2585 | 9.12.32.53:23 | ESTABLISHED | 5060 |

In Table 1, the “local address” indicates the Internet connection that an application local to this system has. For example, the first line indicates that the local address corresponds to an IP address of 9.10.110.33 and a port of 1763. The foreign address indicates some other application (or possibly itself) that the application is communicating with. The other application, with the foreign address, may be on the same system or on some other system. For example, the first line indicates that the application being communicated is at IP address 9.17.136.76 and a port of 1533. Finally, the PID is a process ID that uniquely identifies the application on the system that is associated with the local address.

TCP/IP communications requires that the receiver of the data acknowledge all data that is sent, since TCP/IP guarantees that the receiver will receive the data. Until the receiver sends its acknowledgment, the sending system saves a copy of the data that was sent. Thus, if an acknowledgment is not received in a timely fashion, the data can be retransmitted. As long as the send buffer is not completely full, the application can send additional new data. Once the send buffer is full, the application is no longer allowed to send new data. In order to minimize the amount of time that an application waits to receive an acknowledgment, TCP/IP on the receiving system sends an acknowledgment back as soon as it receives it and does not wait for the receiving application to read the data. TCP/IP has a separate buffer for each connection to receive data for that connection. It will continue to receive data and acknowledge its receipt until that buffer fills up. Once it does, TCP/IP will not receive the data and acknowledge it until the receiving application reads some of the data queued up in the receive buffer. Embodiments of the invention gather and utilize information about the amount of data in the send and receive buffer associated with each local address.

Returning to FIG. 1, on each system (104, 106, 108, 110, and 112) the following information is collected by the workload manager of embodiments of the invention. The TCP/IP data for all connections that applications running on the system 100 have established, which includes information about the local and foreign address, the status of the send and receive buffer associated with every local address, and all pertinent information about the application such as, for example, percentage of CPU used, memory used, etc. The aforementioned information is obtained by using the PID provided in the netstat information. The collected information is utilized by an algorithm, described hereinafter, for creating the topology of the network (i.e., how the systems and applications interact together).

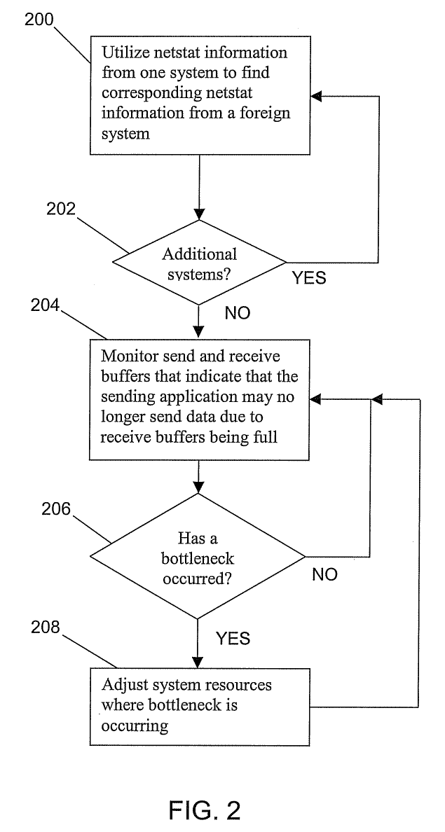

FIG. 2 illustrates a flow diagram of an algorithm of an embodiment of invention that includes the following operations:
1) Utilize the foreign address from the netstat information of one system to find the corresponding netstat information from the foreign system (block 200). For example, the first line of the netstat example of Table 1 above was done on system 9.10.110.33. The application with the PID of 2212 communicates with some application on system 9.17.136.76 that is using port 1533. By looking at the information sent by system 9.17.136.76, the PID of that application and all the information related to that application may be found.
2) Continue to do operation 1 recursively for all systems (illustrated by decision block 202). This will eventually allow the collecting system to know all the applications that are using TCP/IP communications and how they are interconnected.
3) Monitor for any connections where the send and receive buffers indicate that the sending application could no longer send data due to the receive buffers being full (i.e., a bottleneck has occurred) (block 204).
4) Addressing the system bottleneck (block 206 is YES) where the receiving application is running, and the buffers are full, and making adjustments to the amount of system resources it can use (block 208).

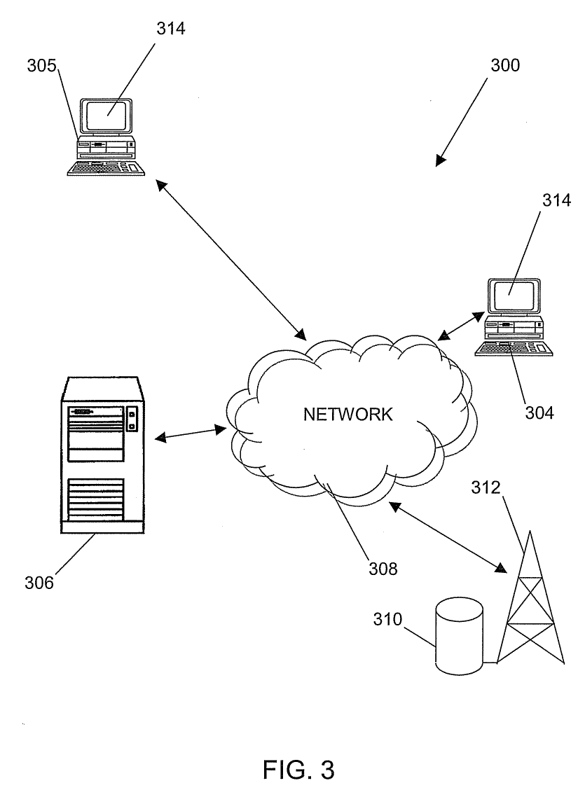

FIG. 3 is a block diagram of an exemplary system 300 for implementing an algorithm for a performance management tool that monitors and manages work and data exchange in a computing/information technology (IT) environment according to embodiments of the invention. The system 300 includes remote devices including one mobile computing devices 304 and desktop computing devices 305 equipped with displays 314 for use with graphical user interface (GUI) aspects of the present invention. The remote devices 304 may be wirelessly connected to a network 308. The network 308 may be any type of known network including a local area network (LAN), wide area network (WAN), global network (e.g., Internet), intranet, etc. with data/Internet capabilities as represented by server 306. Communication aspects of the network are represented by cellular base station 310 and antenna 312. Each remote device 304 may be implemented using a general-purpose computer executing a computer program for carrying out the algorithm described herein. The computer program may be resident on a storage medium local to the remote devices 304, or maybe stored on the server system 306 or cellular base station 310. The server system 306 may belong to a public service. The remote devices 304, and desktop device 305 may be coupled to the server system 306 through multiple networks (e.g., intranet and Internet) so that not all remote devices 302, 304, and desktop device 305 are coupled to the server system 306 via the same network. The remote device 304, desktop device 305, and the server system 306 may be connected to the network 308 in a wireless fashion, and network 308 may be a wireless network. In a preferred embodiment, the network 308 is a LAN and each remote device 304 and desktop device 305 executes a user interface application (e.g., web browser) to contact the server system 306 through the network 308. Alternatively, the remote devices 304 may be implemented using a device programmed primarily for accessing network 308 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for monitoring and managing workloads and data exchange in computing environments, the method comprising:
obtaining a foreign address from a set of netstat information of a first system by a collecting system;
utilizing the foreign address to find the corresponding set of netstat information for a first foreign system;
wherein the process of obtaining foreign addresses is carried out in a recursive maimer until the collecting system records one or more systems being utilized by one or more applications running on the collecting system via transmission control protocol/Internet protocol (TCP/IP) communications, and until the collecting system determines how the systems are interconnected;
monitoring connections between the collecting system and the one or more systems to determine if and where a bottleneck has occurred;
wherein the bottleneck occurs when one or more send and receive buffers are full, and the one or more applications may no longer send data to the one or more receive buffers; and
rectifying the bottleneck by adjusting the amount of system resources the one or more applications may use.

2. The method of claim 1, wherein the netstat information is derived from TCP/IP running in the computing environment.

3. The method of claim 1, wherein the netstat information is derived from an operating system (OS) running in the computing environment.

4. The method of claim 1, wherein the netstat information is derived from at least one of the following: TCP/IP, and OS information in the computing environment.

5. The method of claim 1, wherein the computing environment is at least one of the following: a local area network (LAN), a wide area network (WAN), a wireless network, a global network, Internet, and an intranet.

6. A system for monitoring and managing workloads and data exchange in a computing environment, the system comprising:
a computing environment;
a set of hardware and networking resources;
an algorithm implemented on the set of hardware and networking resources;
wherein the algorithm is configured to obtain a foreign address from a set of netstat information of a first network resource by a collecting network resource;
wherein the algorithm utilizes the foreign address to find the corresponding set of netstat information for a first foreign network resource;
wherein the algorithm operates in a recursive manner until the foreign addresses of one or more network resources utilized by one or more applications running on a collecting network resource via transmission control protocol/Internet protocol (TCP/IP) communications are recorded by the collecting network resource, and until the collecting network resource determines how the one or more network resources are interconnected;
wherein the algorithm monitors connections between the collecting network resource and the one or more network resources to determine if and where a bottleneck has occurred;
wherein the bottleneck occurs when one or more send and receive buffers associated with the collecting network resource and the one or more network resources are full, and the one or more applications may no longer send data to the one or more receive buffers; and
wherein the algorithm rectifies the bottleneck by adjusting the amount of network resources the one or more applications may use.

7. The system of claim 6, wherein the netstat information is derived from TCP/IP running in the computing environment.

8. The system of claim 6, wherein the netstat information is derived from an operating system (OS) running in the computing environment.

9. The system of claim 6, wherein the netstat information is derived from at least one of the following: TCP/IP, and OS information in the computing environment.

10. The system of claim 6, wherein the computing environment is at least one of the following: a local area network (LAN), a wide area network (WAN), a wireless network, a global network, Internet, and an intranet.
